(19) United States
(12) Patent Application Publication
(10) Pub. No.: US 2021/0376305 A1
(43) Pub. Date: Dec. 2, 2021

(54) METHOD FOR PURIFICATION AND LATTICE RECONSTRUCTION OF GRAPHITE IN POWER BATTERY

(71) Applicants: Guangdong Brunp Recycling Technology Co., Ltd., Foshan City (CN); Hunan Brunp Recycling Technology Co., Ltd., Changsha City (CN); Hunan Brunp EV Recycling Co., Ltd., Changsha City (CN)

(72) Inventors: Haijun Yu, Foshan City (CN); Ting Peng, Foshan City (CN); Yinghao Xie, Foshan City (CN); Xuemei Zhang, Foshan City (CN); Yunguang Yang, Foshan City (CN); Yingnan Wang, Foshan City (CN)

(21) Appl. No.: 16/925,310

(22) Filed: Jul. 9, 2020

(30) Foreign Application Priority Data
Jun. 1, 2020 (CN) 2020104855822

(51) Int. Cl. H01M 4/04; H01M 4/1393; H01M 4/1395

(52) U.S. Cl. CPC H01M 4/0471; H01M 4/1395; H01M 4/1393

(57) ABSTRACT

Disclosed is a method for purification and lattice reconstruction of graphite in a power battery, which includes the following steps: subjecting a waste power battery to discharging, coarse breaking, pyrolysis, fine breaking and sorting sequentially to obtain electrode material powder; mixing the electrode material powder with a metal extractant, standing still, then washing with a purifying agent A, filtering to obtain a filter residue A, mixing the filter residue A with the metal extractant, standing still, then washing with a purifying agent B, and filtering to obtain a crude graphite; subjecting the crude graphite to the de-organic treatment, cooling, ball milling, and ventilation replacement to obtain a primary purified graphite; and introducing a rare gas into a primary purified graphite to repair the graphite lattice.

### CROSS REFERENCE TO RELATED APPLICATIONS

This application claims priority under 35 U.S.C. § 119(a) to Chinese patent application number 2020104855822, filed on Jun. 1, 2020, the entire teachings of which are incorporated herein by reference.

### BACKGROUND OF THE INVENTION

### Field of the Invention

The disclosure relates to the field of battery graphite, and in particular relates to a method for purification and lattice reconstruction of graphite in a power battery.

### Description of the Related Art

Driven by policies, the new energy industry is booming. At the same time, the number of retired power batteries has increased year by year. The previously installed power batteries have entered or will enter the retirement period from 2018 to 2025. According to the fact that a service life of battery is estimated to be 8 years for a passenger electric vehicle and 5 years for a commercial power electric vehicle, it is estimated that the retired power batteries will reach 32.94 GWh in 2022, and the market scale is expected to reach 11 billion Yuan in 2020 and 38 billion Yuan by 2025. Therefore, recycling the retired power batteries has extremely high economic benefits and social value.

In recent years, the scrap peak of lithium batteries has brought a large number of waste batteries. In the face of such huge amount of graphite in the waste batteries, if landfill or high-temperature incineration is adopted blindly, although the immediate dilemma can be solved preliminarily, in the long run, such approaches not only exacerbate the dust pollution in the atmosphere and the greenhouse effect, but also affect the sustainable development of the graphite industry. The recycling and harmless treatment technologies of waste batteries have become the focus of attention.

The traditional method for recovering and regenerating graphite uses cellulose acetate as a surface modifier for coating, and performs the surface modification under a nitrogen atmosphere at 300-900° C., such as the method disclosed in “Method for Recovering and Restoring Anode Material Graphite of Waste Lithium Ion Battery” (CN101710632A). However, such traditional recovering method cannot effectively remove the metal impurities and organic impurities in the graphite anode material, and the recovered graphite has a low degree of graphitization, poor electrical performance and instability, and the technology is backward. In addition, although the existing one-time leaching treatment for purification of metals can effectively recover the metals, it is difficult to ensure the purity of graphite. Especially, when performing lattice repair on waste graphite materials, impurities will be introduced into the graphite lattice and it is difficult to ensure the purity thereof.

Therefore, there is an urgent need to develop a method for purification and lattice reconstruction of graphite in a power battery with low cost of raw materials and high efficiency.

### BRIEF SUMMARY OF THE INVENTION

An objective of the disclosure is to provide a method for purification and lattice reconstruction of graphite in a power battery, which is low in raw material cost and high in efficiency, and the batteries assembled by the obtained graphite anode material still have good electrochemical performance after 1600 cycles, which is superior to similar products on the market.

In order to achieve the above object, the disclosure adopts the following technical solutions.

In one aspect of the disclosure, there is provided a method for purification and lattice reconstruction of graphite in a power battery including the following steps:
1) subjecting a waste power battery to discharging, coarse breaking, pyrolysis, fine breaking and sorting sequentially to obtain electrode material powder, copper powder, aluminum powder and iron powder, respectively;
2) mixing the electrode material powder with a metal extractant, standing still, then washing with a purifying agent A, filtering to obtain a filter residue A, mixing the filter residue A with the metal extractant, standing still, then washing with a purifying agent B, and filtering to obtain a crude graphite;
3) subjecting the crude graphite to the de-organic treatment, cooling, ball milling, and ventilation replacement to obtain a primary purified graphite; and
4) introducing a rare gas into the primary purified graphite to repair the graphite lattice; wherein in step (2), the purifying agent A is a mixed solution of hydrochloric acid, ethanol and acetone, and the purifying agent B is a mixed solution of deionized water, ethanol and acetone.

Preferably, the pyrolysis in step (1) is carried out in an oxygen-free environment at a temperature of 350° C.-800° C. for 1-20 h.

Preferably, the metal extractant in step (2) is one of a mixed solution of aqua regia and an oxidant, and aqua regia.

Further preferably, the oxidant is at least one of hydrogen peroxide, sodium peroxide, potassium peroxide, sodium hypochlorite or potassium hypochlorite.

More preferably, the oxidant has a concentration of 0.05-1 mol/L.

More preferably, the aqua regia has a concentration of 10%-50%.

Preferably, the mass ratio of hydrochloric acid, ethanol and acetone is 1 (1-5):(1-5). Preferably, the mass ratio of deionized water, ethanol and acetone is 1:(1-5):(1-5).

Preferably, the de-organic treatment in step (3) includes placing the crude graphite in a vacuum furnace at a heating rate of 1-5° C./min to be heated to 200° C.-250° C. for de-organic treatment for 2-4 h.

Preferably, in step (3), the graphite is rotated at a speed of 100-3000 r/min for 20-60 min.

Preferably, the replacement in step (3) includes introducing a replacement gas at a flow rate of 5-30 mL/min, and then heating to 250° C.-450° C. at a heating rate of 1-5° C./min for replacement, and the replacement time is 20-40 min.

More preferably, the replacement gas is a gas mixture of H₂ and N₂.

Preferably, the rare gas in step (4) is He with a volumetric purity of 99.999%.

Preferably, the specific process of repairing graphite lattice in step (4) includes introducing the rare gas at a flow rate of 5-30 mL/min within 40-80 min, closing an inlet valve and an outlet valve, and heating to a temperature of 2400° C.-2600° C. at a heating rate of 10-20° C./min, keeping the temperature for 10-30 min, then heating to 2600° C.-3200° C. at a heating rate of 3-10° C./min, and repairing the graphite having damaged lattices within 6-10 h to obtain a battery-grade graphite.

In another aspect of the disclosure, there is provided a graphite produced by the method described above.

### Beneficial Effects

1) The disclosure adopts a method similar to vacuum evaporation to remove the organic components in the graphite. According to the disclosure, the organic impurities are evaporated or sublimated into gaseous particles under high temperature and vacuum conditions, and the gaseous particles are completely separated from the graphite under negative pressure, thus the organic impurities can be removed. After the de-organic treatment, secondary bonding will not occur between the graphite and the organic impurities again, thereby obtaining the high-purity graphite.
2) The disclosure uses replacement gas to deeply clean the graphite, so that the species adsorbed on the surface of graphite are completely desorbed before graphitization treatment, ensuring that no impurity atoms are arranged into the graphite lattice before graphitization, and the impurity removal at the atomic level is achieved, so that the impurity removal is effectively achieved, and the surface activity of the graphite is prevented from changing by the active functional groups on the surface of graphite, thereby forming graphite with intact crystal form.
3) The disclosure adopts a carbon source-free repairing, the atoms on the grid rearranges under He atmosphere and high temperature conditions, thereby realizing the self-repairing of the graphite anode material, forming a relatively intact graphite crystal form, and achieving the effect of self-healing the graphite defects. Therefore, the batteries assembled by the obtained graphite anode material have good electrochemical performance after 1600 cycles, which is superior to similar products on the market.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is an SEM image of graphite prepared in Embodiment 1;

FIG. 2 is a flow chart of a method for purification and lattice reconstruction of graphite in a power battery according to Embodiments 1-3 of the disclosure;

FIG. 3 is an XRD pattern of graphite prepared in Embodiment 1; and

FIG. 4 is a graph showing the cycle performance of graphite prepared in Embodiment 1 and Comparative Embodiment 1.

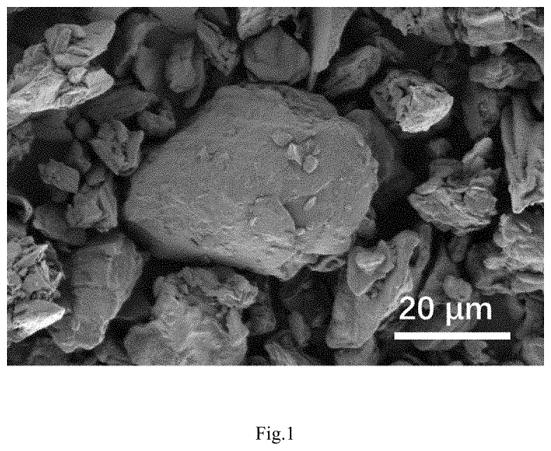

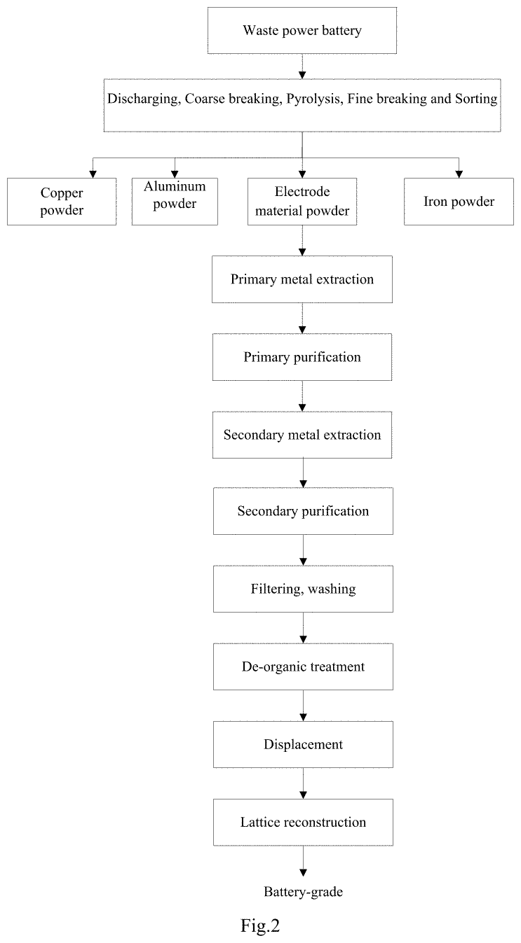

### DETAILED DESCRIPTION OF THE INVENTION

In order to make those skilled in the art more clearly understand the technical solutions of the disclosure, the following embodiments are set forth for description. It should be noted that the following embodiments do not constitute a limitation on the protection scope of the disclosure.

Unless particularly stated, the raw materials, reagents or devices used in the following embodiments can all be obtained from conventional commercial sources, or can be obtained by existing known methods.

### Embodiment 1

A method for purification and lattice reconstruction of graphite in a power battery of this embodiment includes the following specific steps:
a) subjecting a waste power battery to discharging, coarse breaking, pyrolysis, fine breaking and sorting sequentially to obtain electrode material powder, copper foil, aluminum foil and iron powder, respectively;
b) mixing the electrode material powder with aqua regia having a concentration of 20% and hydrogen peroxide having a concentration of 0.1 mol/L at a solid-liquid ratio of 1:1 in a metal extraction tank and standing still for 4 hours to extract metal elements in the graphite anode, then washing with hydrochloric acid having a concentration of 2%, ethanol, and acetone at a ratio of 1:1:1, filtering to obtain a filter residue A and mixing the filter residue A with aqua regia having a concentration of 10% and hydrogen peroxide having a concentration of 0.05 mol/L at a solid-liquid ratio of 1:1 in a metal extraction tank, and standing still for 4 hours, extracting the metal elements in the graphite anode again, washing the same with deionized water, ethanol and acetone at a ratio of 1:1:1, and filtering to obtain a crude graphite;
c) subjecting the crude graphite to de-organic treatment in a vacuum furnace at 200° C. (with a heating rate of 1° C./min) for 2 h, ball-milling the same at 100 r/min for 20 min after natural cooling, and then placing the de-organized crude graphite in a high-temperature furnace, and introducing a replacement gas (H₂ with a concentration of 2%) at a flow rate of 5 mL/min, then performing replacement at a temperature of 250° C. (with a heating rate of 1° C./min) for 20 min to remove surface adsorbed species; and
d) after the replacement is completed, introducing He with a volumetric purity of 99.999% at a flow rate of 5 mL/min at 250° C. within 40 min, closing an inlet valve and an outlet valve, and heating to a temperature of 2400° C. at a heating rate of 10° C./min, keeping the temperature for 10 min, then heating to 2600° C. at a heating rate of 3° C./min, and repairing the graphite having damaged lattices within 6 h to obtain a battery-grade graphite.

### Embodiment 2

A method for purification and lattice reconstruction of graphite in a power battery of this embodiment includes the following specific steps:
e) subjecting a waste power battery to discharging, coarse breaking, pyrolysis, fine breaking and sorting sequentially to obtain electrode material powder, copper foil, aluminum foil and iron powder, respectively;
f) mixing the electrode material powder with aqua regia having a concentration of 35% and sodium hypochlorite having a concentration of 0.5 mol/L at a solid-liquid ratio of 1:3 in a metal extraction tank and standing still for 8 hours at 25° C. to extract metal elements in the graphite anode, then washing with hydrochloric acid having a concentration of 15%, ethanol, and acetone at a ratio of 1:3:3, filtering to obtain a filter residue A and mixing the filter residue A with aqua regia having a concentration of 20% and sodium hypochlorite having a concentration of 0.15 mol/L at a solid-liquid ratio of 1:3 in the metal extraction tank, and standing still for 8 hours, extracting the metal elements in the graphite anode again, washing the same with deionized water, ethanol and acetone at a ratio of 1:3:3, and filtering to obtain a crude graphite;
g) subjecting the crude graphite to de-organic treatment in a vacuum furnace at 230° C. (with a heating rate of 3° C./min) for 3 h, ball-milling the same at 2000 r/min for 40 min after natural cooling, and then placing the de-organized crude graphite in a high-temperature furnace, and introducing a replacement gas (H₂ with a concentration of 15%) at a flow rate of 5 mL/min, then performing replacement at a temperature of 300° C. (with a heating rate of 3° C./min) for 30 min to remove surface adsorbed species; and
h) after the replacement is completed, introducing He with a purity of 99.999% at a flow rate of 20 mL/min at 300° C. within 60 min, closing an inlet valve and an outlet valve, and heating to a temperature of 2500° C. at a heating rate of 15° C./min, keeping the temperature for 20 min, then heating to 3000° C. at a heating rate of 7° C./min, and repairing the graphite having damaged lattices within 8 h to obtain a battery-grade graphite.

### Embodiment 3

A method for purification and lattice reconstruction of graphite in a power battery of this embodiment includes the following specific steps:

(1) subjecting a waste power battery to discharging, coarse breaking, pyrolysis, fine breaking and sorting sequentially to obtain electrode material powder, copper foil, aluminum foil and iron powder, respectively;

(2) mixing the electrode material powder with aqua regia having a concentration of 50% and potassium hypochlorite having a concentration of 1 mol/L at a solid-liquid ratio of 1:5 in a metal extraction tank and standing still for 12 hours to extract metal elements in the graphite anode, then washing with hydrochloric acid having a concentration of 30%, ethanol, and acetone at a mass ratio of 1:5:5, filtering to obtain a filter residue A and mixing the filter residue A with aqua regia having a concentration of 30% and potassium hypochlorite having a concentration of 0.3 mol/L at a solid-liquid ratio of 1:5 in the metal extraction tank, and standing still for 12 hours, extracting the metal elements in the graphite anode again, washing the same with deionized water, ethanol and acetone at a mass ratio of 1:5:5, and filtering to obtain a crude graphite;

(3) subjecting the crude graphite to de-organic treatment in a vacuum furnace at 250° C. (with a heating rate of 5° C./min) for 4 h, ball-milling the same at 3000 r/min for 60 min after natural cooling, and then placing the de-organized crude graphite in a high-temperature furnace, and introducing a replacement gas (H₂ with a concentration of 30%) at a flow rate of 30 mL/min, then performing replacement at a temperature of 450° C. (with a heating rate of 5° C./min) for 40 min to remove surface adsorbed species; and

(4) after the replacement is completed, introducing He with a volumetric purity of 99.999% at a flow rate of 20 mL/min at 450° C. within 40 min, closing an inlet valve and an outlet valve, and heating to a temperature of 2600° C. at a heating rate of 15° C./min, keeping the temperature for 30 min, then heating to 3200° C. at a heating rate of 10° C./min, and repairing the graphite having damaged lattices within 10 h to obtain a battery-grade graphite.

### Comparative Embodiment 1

A method for preparing artificial graphite anode material includes the following steps:
i) subjecting a waste power battery to discharging, coarse breaking, pyrolysis, fine breaking and sorting sequentially, taking and leaching an electrode material powder and 0.1 mol/L of sulfuric acid at a solid-liquid volume ratio of 1:5 for 6 hours, then washing with 2% of hydrochloric acid, and filtering to obtain graphite.

Performance Test:

The graphite obtained respectively in the above Embodiments 1-3 and Comparative Embodiment 1 was used as the anode, and a lithium sheet was used as the cathode. The graphite and the lithium sheet were assembled into a button battery, and the initial discharge test was carried out at a rate of 1 C. The results are shown in Table 2 and Table 3. It can be seen from Table 1 that the regenerated graphite in Embodiment 2 has low impurity content, and the degree of graphitization reaches 96%, while the degree of graphitization in Comparative Embodiment 1 is only 92%. It can be seen according to Table 2 that, at a rate of 1 C, the initial discharge specific capacity of the regenerated graphite anode material of the disclosure is higher than that of graphite recovered by an ordinary method, and the initial discharge specific capacity of Embodiment 2 is 362.3 mAh/g, while the initial discharge specific capacity of Comparative Embodiment is only 333.1 mAh/g. It can be seen according to Table 3 that, at a rate of 1 C, the cycle life of the regenerated graphite anode material of the disclosure is higher than that of graphite recovered by an ordinary method, and the capacity retention rate of Embodiment 2 after 1600 cycles at 1 C is 96.6%, while the capacity retention rate of Comparative Embodiment 1 is only 92.8%. Table 4 shows the concentration and ash content of the impurity elements obtained in Embodiment 2 and Comparative Embodiment 2 after extracting the metal elements by the acid solution. It can be seen from Table 4 that after two acid extractions in Embodiment 2, the content of metal impurities in graphite is significantly lower than that of metal impurities in Comparative Embodiment 2 after one acid extraction.

The results are as shown in Table 1:

TABLE 1
Composition Analysis and Physical Properties of Graphite

| | Embodi- | Embodi- | Embodi- | Comparative |
|---|---|---|---|---|
| Item | ment 1 | ment 2 | ment 3 | Embodiment 1 |
| Ash content % | 0.046 | 0.043 | 0.041 | 0.088 |
| Moisture % | 0.0331 | 0.0335 | 0.0329 | 0.0656 |
| Volatile % | 0.0193 | 0.0198 | 0.0211 | 0.0466 |
| D50 μm | 18.59 | 18.61 | 18.56 | 18.63 |
| Degree of | 95 | 96 | 94 | 92 |
| graphiti- | | | | |
| zation % | | | | |
| Fixed carbon | 99.96 | 99.98 | 99.95 | 99.70 |
| content % | | | | |

TABLE 2
Performance of button battery of graphite

| | Embodi- | Embodi- | Embodi- | Comparative |
|---|---|---|---|---|
| Item | ment 1 | ment 2 | ment 3 | Embodiment 1 |
| Initial discharge | 361.9 | 362.3 | 362.1 | 333.1 |
| specific capacity | | | | |
| mAh/g | | | | |
| Initial charge- | 93.8 | 93.9 | 93.9 | 91.2 |
| discharge | | | | |
| efficiency % | | | | |

TABLE 3
Full battery cycle performance of graphite

| | Embodi- | Embodi- | Embodi- | Comparative |
|---|---|---|---|---|
| Item | ment 1 | ment 2 | ment 3 | Embodiment 1 |
| Discharge capacity | 95.9 | 96.6 | 96.3 | 92.8 |
| retention rate % | | | | |
| after 1600 cycles | | | | |
| at 1 C | | | | |

TABLE 4
Impurity content of graphite after metal extraction

| | Impurities | | | | | | | | |
|---|---|---|---|---|---|---|---|---|---|
| | Ni | Co | Mn | Li | Fe | Al | Cu | Total | Ash |
| | (%) | (%) | (%) | (%) | (%) | (%) | (%) | (%) | (%) |
| Embodiment 2 | 0.001 | 0.003 | 0.001 | 0.001 | 0.002 | 0.001 | 0.001 | 0.01 | 0.019 |
| Comparative | 0.01 | 0.008 | 0.005 | 0.02 | 0.05 | 0.01 | 0.004 | 0.107 | 0.183 |
| Embodiment 2 | | | | | | | | | |

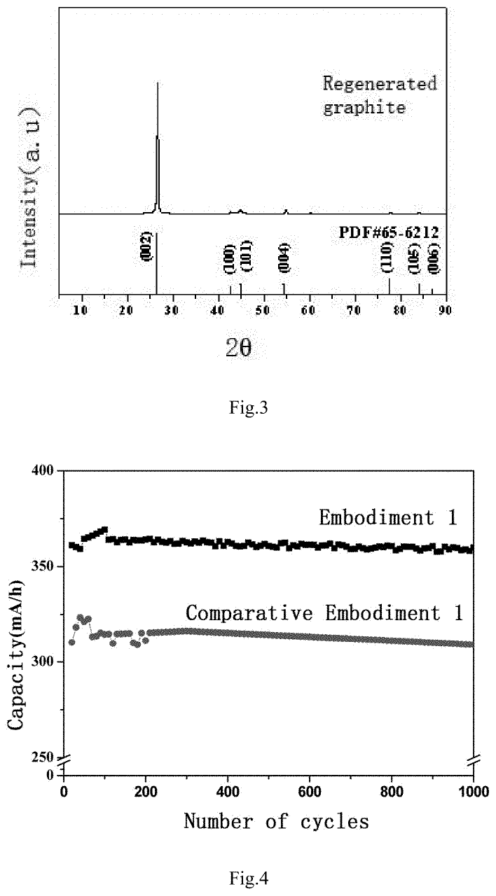

From the XRD pattern of the graphite prepared in Embodiment 1 (FIG. 3), it is found that in comparison with PDF #65-6212, the peak at around 26.5° corresponds to the crystal plane (002) of the regenerated graphite in Embodiment 1, which shows that the crystal form of the regenerated graphite sample of Embodiment 1 is better. From the graphs of the cycle performance of the graphite prepared in Embodiment 1 and Comparative Embodiment 1 (FIG. 4), it is found that the capacity and cycle stability of the regenerated graphite of Embodiment 1 are better than those of Comparative Embodiment 1.

A detailed introduction to a method for purification and lattice reconstruction of graphite in a power battery according to the disclosure is provided above. The principles and implementations of the disclosure are explained by way of specific embodiments herein. The above embodiments are only provided to facilitate the understanding of the method of the disclosure and core concepts thereof, including the best mode, and also enables any person skilled in the art to practice the disclosure, including manufacturing and using any device or system, and implementing any combined method. It should be noted that several improvements and modifications may be made by an ordinary person skilled in the art without departing from the principles of the present disclosure, and that such improvements and modifications also fall within the protection scope of the appended claims of the present disclosure. The scope of patent protection of the disclosure is defined by the claims, and other embodiments conceivable by those skilled in the art may be included. If these other embodiments have structural elements that are not different from the literal expressions of the claims, or if they include equivalent structural elements that are not substantially different from the literal expressions of the claims, these other embodiments should also be included within the scope of the claims.

Of note, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, and/or “including,” when used in this specification, specify the presence of stated features, integers, steps, operations, elements, and/or components, but do not preclude the presence or addition of one or more other features, integers, steps, operations, elements, components, and/or groups thereof.

As well, the corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

1. A method for purification and lattice reconstruction of graphite in a power battery, comprising:
(1) subjecting a waste power battery to discharging, coarse breaking, pyrolysis, fine breaking and sorting sequentially to obtain electrode material powder, copper powder, aluminum powder and iron powder, respectively;
(2) mixing the electrode material powder with a metal extractant, standing still, then washing with a purifying agent A, filtering to obtain a filter residue A, mixing the filter residue A with the metal extractant, standing still, then washing with a purifying agent B, and filtering to obtain a crude graphite;
(3) subjecting the crude graphite to the de-organic treatment, cooling, ball milling, and ventilation replacement to obtain a primary purified graphite; and
(4) introducing a rare gas into the primary purified graphite to repair graphite lattice; wherein in step (2), the purifying agent A is a mixed solution of hydrochloric acid, ethanol and acetone, and the purifying agent B is a mixed solution of deionized water, ethanol and acetone.

2. The method for purification and lattice reconstruction of graphite in a power battery of claim 1, wherein the pyrolysis in step (1) is carried out in an oxygen-free environment at a temperature of 350° C.-800° C. for 1-20 h.

3. The method for purification and lattice reconstruction of graphite in a power battery of claim 1, wherein the metal extractant in step (2) is one of a mixed solution of aqua regia and an oxidant, and aqua regia.

4. The method for purification and lattice reconstruction of graphite in a power battery of claim 3, wherein the oxidant is at least one of hydrogen peroxide, sodium peroxide, potassium peroxide, sodium hypochlorite or potassium hypochlorite.

5. The method for purification and lattice reconstruction of graphite in a power battery of claim 1, wherein the de-organic treatment in step (3) comprises placing the crude graphite in a vacuum furnace at a heating rate of 1-5° C./min to be heated to 200° C.-250° C. for the de-organic treatment for 2-4 h.

6. The method for purification and lattice reconstruction of graphite in a power battery of claim 1, wherein the replacement in step (3) comprises introducing a replacement gas at a flow rate of 5-30 mL/min, and then heating to 250° C.-450° C. at a heating rate of 1-5° C./min for replacement for 20-40 min.

7. The method for purification and lattice reconstruction of graphite in a power battery of claim 6, wherein the replacement gas is a gas mixture of H2 and N2.

8. The method for purification and lattice reconstruction of graphite in a power battery of claim 1, wherein the rare gas in step (4) is He with a volumetric purity of 99.999%.

9. The method for purification and lattice reconstruction of graphite in a power battery of claim 1, wherein the repairing graphite lattice in step (4) comprises:
introducing a rare gas at a flow rate of 5-30 mL/min within 40-80 min, closing an inlet valve and an outlet valve, and heating to a temperature of 2400° C.-2600° C. at a heating rate of 10-20° C./min, keeping the temperature for 10-30 min, then heating to 2600° C.-3200° C. at a heating rate of 3-10° C./min, and repairing the graphite having damaged lattices within 6-10 h.

10. A graphite produced by:
(1) subjecting a waste power battery to discharging, coarse breaking, pyrolysis, fine breaking and sorting sequentially to obtain electrode material powder, copper powder, aluminum powder and iron powder, respectively;
(2) mixing the electrode material powder with a metal extractant, standing still, then washing with a purifying agent A, filtering to obtain a filter residue A, mixing the filter residue A with the metal extractant, standing still, then washing with a purifying agent B, and filtering to obtain a crude graphite;
(3) subjecting the crude graphite to the de-organic treatment, cooling, ball milling, and ventilation replacement to obtain a primary purified graphite; and
(4) introducing a rare gas into the primary purified graphite to repair graphite lattice; wherein in step (2), the purifying agent A is a mixed solution of hydrochloric acid, ethanol and acetone, and the purifying agent B is a mixed solution of deionized water, ethanol and acetone.
